(19) United States
(12) Patent Application Publication
(10) Pub. No.: US 2012/0328184 A1
(43) Pub. Date: Dec. 27, 2012

(54) OPTICALLY CHARACTERIZING OBJECTS

(76) Inventor: Feng Tang, Mountain View, CA (US)

(21) Appl. No.: 13/166,197

(22) Filed: Jun. 22, 2011

(51) Int. Cl. G06K 9/62; G06F 17/30

(52) U.S. Cl. 382/159; 707/706; 707/E17.108

(57) ABSTRACT

Systems and methods are provided for optically characterizing an object. A method includes querying an image search engine for the object; extracting image features from multiple images returned by the search engine in response to the query; clustering the image features extracted from the images returned by the search engine according to similarities in optical characteristics of the image features; and determining a set of image features most representative of the object based on the clustering.

### BACKGROUND

In the field of computer vision, computers extract information from optical images to perform certain tasks. Computer vision can be used to accomplish tasks as diverse as the navigation of vehicles, the diagnosis of medical conditions, and the recognition of printed text. In many applications of computer vision, the computer is programmed to recognize and identify objects in an optical image. For example, in a vehicle navigation application of computer vision, a computer may be tasked with analyzing an image provided by a camera to identify a road and deduce a correct path of travel. In optical character recognition, a computer identifies printed characters and puts the characters together to form meaningful text.

Traditional methods for training a machine to detect and recognize objects can be quite tedious. For example, to train a computer to recognize a certain object, a user generally many need to track down a large number of training images showing the object, crop the images such that the object is prominently shown in each image, and align the objects shown in each image. This process can often be time consuming and difficult.

### BRIEF DESCRIPTION OF THE DRAWINGS

The accompanying drawings illustrate various examples of the principles described herein and are a part of the specification. The illustrated examples are merely examples and do not limit the scope of the disclosure.

FIG. 1 is a block diagram of an illustrative system for optically characterizing objects, according to one example of principles described herein.

FIG. 2 is a flowchart diagram of an illustrative method of optically characterizing an object, according to one example of principles described herein.

FIG. 3 is a flowchart diagram of an illustrative method of optically characterizing an object, according to one example of principles described herein.

FIG. 4 is a flowchart diagram of an illustrative method of optically characterizing an object, according to one example of principles described herein.

FIG. 5 is a flowchart diagram of an illustrative method of optically recognizing an object in an image, according to one example of principles described herein.

FIG. 6 is a block diagram of an illustrative computing device which may implement a method of optically characterizing an object, according to one example of principles described herein.

Throughout the drawings, identical reference numbers may designate similar, but not necessarily identical, elements.

### DETAILED DESCRIPTION

As described above, assembling a collection of training images to teach a machine to detect and recognize a certain object can be time-consuming and difficult. Moreover, in many computer vision applications, a large database of recognizable objects may be desired. In such applications, traditional methods of object recognition training may involve a separate collection of training images for each object to be recognized, thereby substantially increasing the effort.

The present specification discloses systems, methods, and computer program products for optically characterizing and recognizing objects shown in images. Using the systems, methods, and computer program products of the present specification, a set of training images for a certain object can be obtained by querying an image search engine for that object. The optical features of each image returned by the image search engine in response to the query are detected and clustered together according to optical similarities. Based on the clustering, a set of optical features most representative of the object can be determined and used to train a machine to recognize the object in other images.

As used in the present specification and in the appended claims, the term “object” may refer to something material that may be perceived optically.

As used in the present specification and in the appended claims, the term “image feature” may refer to an optically distinguishable portion of an image.

As used herein, the term “includes” means includes but not limited to, the term “including” means including but not limited to. The term “based on” means based at least in part on.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with that example is included as described, but may not be included in other examples.

The principles disclosed herein will now be discussed with respect to illustrative systems, methods, and computer program products for optically characterizing and detecting objects in images.

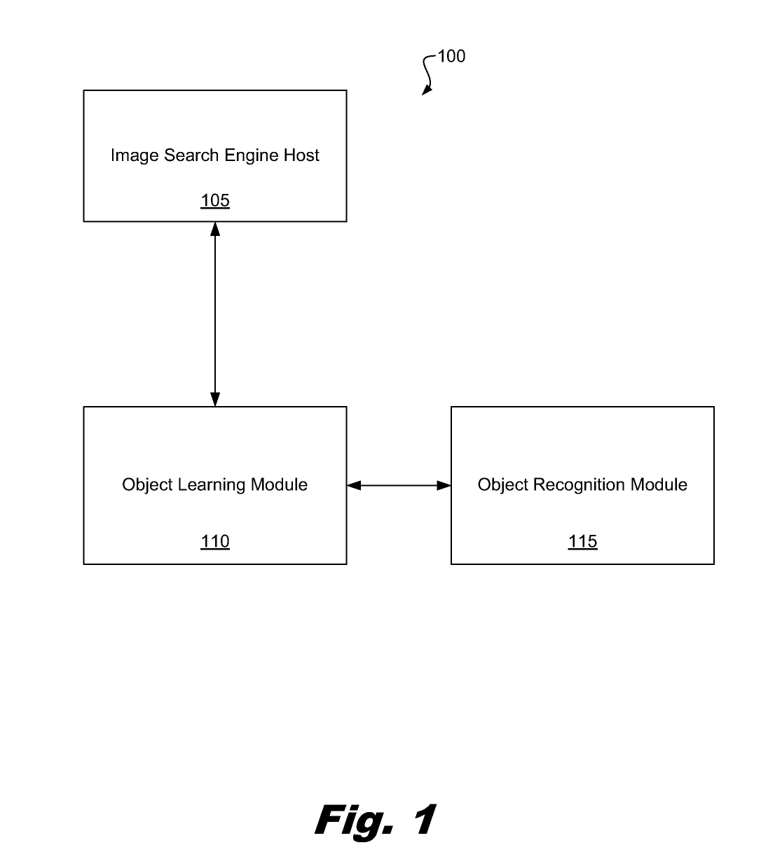

FIG. 1 is a block diagram of an illustrative system (100) for optically characterizing and recognizing objects. The illustrative system (100) includes an image search engine host (105), an object learning module (110), and an object recognition module (115). Each of the image search engine host (105), the object learning module (110), and the object recognition module (115) may be implemented by machine-readable code executed by at least one processor.

In certain examples, the search engine host (105), the object learning module (110), and the object recognition module (115) may each be implemented by the same hardware. Alternatively, one or more of the search engine host (105), the object learning module (110), and the object recognition module (115) may be implemented by a separate set of hardware. In one example, the image search engine host may be implemented by a server that is communicatively coupled via a computer network to a processor-based device that implements both the object learning module (110) and the object recognition module (115).

The image search engine host (105) may have access to a large repository of images. In certain examples, the image search engine may store a cache of images available over a large network, such as the Internet. The image search engine host (105) may maintain an index of text associated with each of the images. The text associated with a particular image may have been displayed near that image in an original source of that image. Additionally or alternatively, the text associated with a particular image may include metadata or text written by a human viewer of the image.

The image search engine host (105) may be programmed to process and respond to search queries received from external entities, such as the object learning module (110). The queries received by the image search engine host (105) may be in the form of a string of text characters. Upon receiving an image search query, the image search engine host (105) may search through the index of text associated with each of the images to determine whether some permutation or variation of the text of the query is present in any of the text associated with the images. The image search engine host (105) returns any images in the repository that are relevant to the query to the external entity making the query.

The object learning module (110) may be configured to select an object, query the image search engine host (105) for that object, and characterize the object based on the images returned by the image search engine host (105) in response to the query. Once the object learning module (110) has characterized the object, that characterization may be provided to the object recognition module (115). The object recognition module (115) may then identify the object in images received by the object recognition module (115) based on the characterization provided by the object learning module (110).

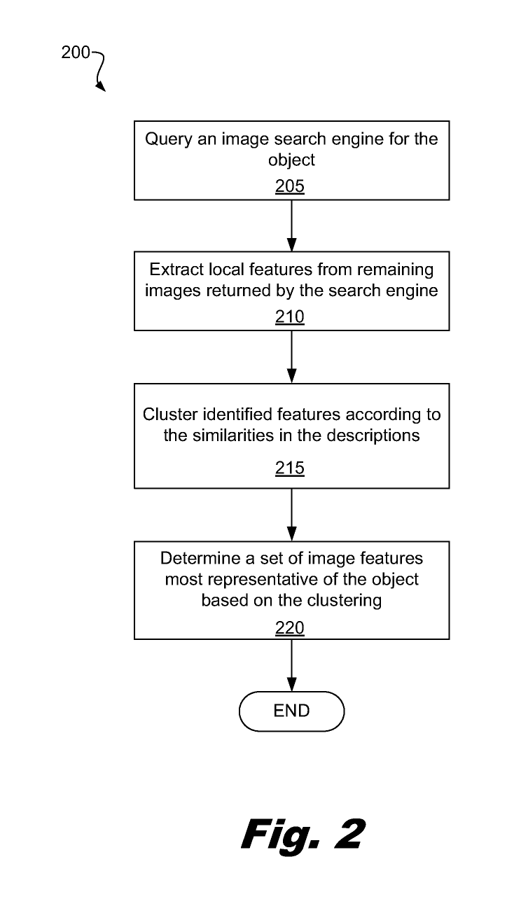

FIG. 2 is a flowchart of an illustrative method (200) of object characterization. The method (200) may be performed, for example, by the hardware implementing an object recognition module (115), FIG. 1).

In the method (200) of FIG. 2, an image search engine is queried (block 205) for a specific object. In response to the query, the image search engine returns a plurality of images associated with the text of the query.

Local optical features are extracted (block 210) from each of the images returned by the search engine are extracted. The features may be detected in the images returned by the search engine host (105) using any of a number of approaches to local feature detection. For example, local features may be detected using a Hessian affine method. The feature detection process may localize feature points and extract local patches around the feature points.

A clustering process (block 215) is performed on each of the extracted features to group similar features together. Based on the results of the clustering, a set of image features most representative of the object of the query is determined (block 220). The set of most representative features may then be used by, for example, an object recognition module (115, FIG. 1) to identify the object in unknown images.

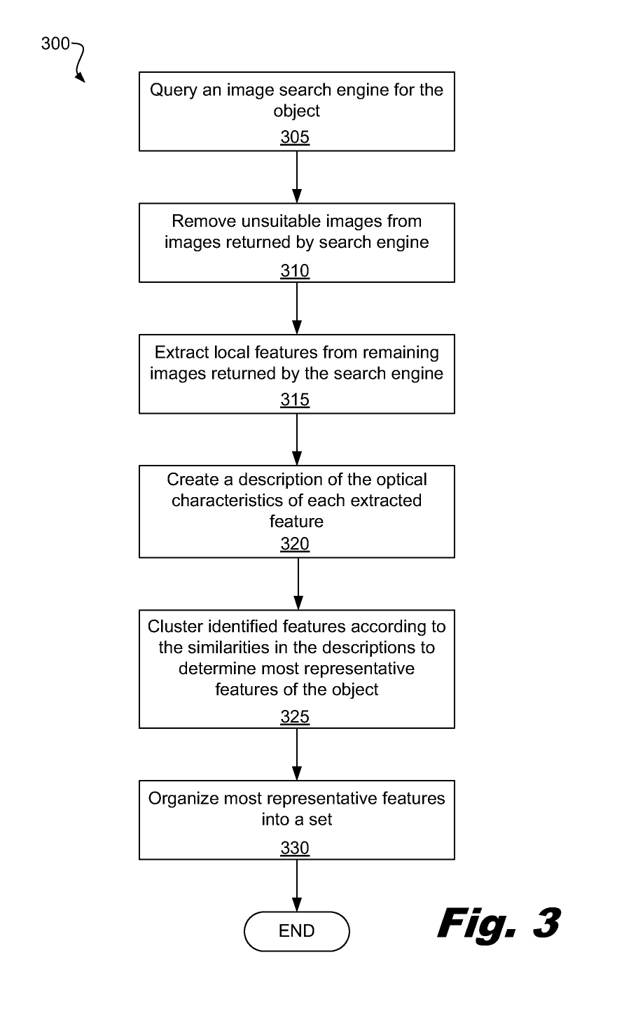

FIG. 3 is a flowchart of a more detailed illustrative method (300) of object characterization. The method (300) may be performed, for example, by the hardware implementing an object recognition module (115), FIG. 1).

In the method (300) of FIG. 3, an image search engine is queried (block 305) for a specific object. In response to the query, the image search engine returns a plurality of images associated with the text of the query. Unsuitable images (i.e., images that are too small, duplicate images, etc.) are removed (block 310) from the plurality of images returned by the search engine. While most of the returned images may be relevant to the query, some of the images may be completely irrelevant, and others may contain many distracting features that are not immediately related to the object. This is the case due to the fact that most current image search engines are text based and ignore the optical content of the images.

The optical features of the object to be characterized are identified under the assumption that the majority of images returned to the object learning module (110) by the search engine host (105) are relevant to the object and that the features of the object are substantially consistent throughout the returned images. Under this assumption, background and irrelevant features in the images returned by the search engine host (105) should be outliers in the feature space, and can be removed using feature clustering.

As such, local optical features are extracted (block 315) from each of the images returned by the search engine are extracted. The features may be detected in the images returned by the search engine host (105) using any of a number of approaches to local feature detection. For example, local features may be detected using a Hessian affine method. The feature detection process may localize feature points and extract local patches around the feature points.

A description is then generated (block 320) for each optical feature extracted from each of the images returned by the search engine. In some examples, a new feature descriptor called ordinal spatial intensity distribution (OSID) may be used to create generate the descriptions. OSID is invariant to any monotonically increasing changes. While traditional feature descriptions can be invariant to intensity shift or affine brightness changes, they cannot handle more complex nonlinear brightness changes, which often occur due to nonlinear camera response, variations in capture device parameters, temporal changes in illumination, and viewpoint-dependent illumination and shadowing. By contrast, in OSID, a configuration of spatial patch sub-divisions is defined, and the descriptor is obtained by computing a 2-D histogram in the intensity ordering and spatial sub-division spaces.

Extensive experiments show that the OSID descriptor significantly outperforms many traditional descriptors under complex brightness changes. Moreover, the experiments demonstrate that the OSID descriptor exhibits superior performance over traditional feature descriptors in the presence of image blur, viewpoint changes, and JPEG compression.

One of the features of the OSID feature descriptor of the present specification is that the relative ordering of the pixel intensities in a local patch remains unchanged or stable under monotonically increasing brightness changes. However, simply extracting the feature vector based on the raw ordinal information of pixel intensities may not be appropriate due to the fact that the dimension of the feature vector may be too high (i.e., equal to the number of pixels in the patch). Furthermore, such an approach would make the features sensitive to perturbations such as image distortions or noise.

In light of these considerations, the OSID feature descriptor of the present specification is constructed by rasterizing a 2-D histogram where the pixel intensities are grouped (or binned) in both ordinal space and spatial space. Binning the pixels in the ordinal space ensures that the feature is invariant to complex brightness changes while binning the pixels spatially captures the structural information of the patch that would have been lost if the feature were obtained from a naïve histogram of the pixels.

After the features have been extracted from each of the plurality of images returned by the search engine and an OSID feature description has been created for each extracted feature, a clustering process (block 325) is performed on each of the extracted features to group similar features together. Similarity may be determined using the OSID feature descriptions of the extracted features.

The rationale behind feature clustering is that although the image search engine result may be noisy, the object of interest (e.g., the subject of the query) should appear fairly consistently in most of the images returned by the image search engine. Thus, while background features may appear in most images, they will likely not be consistent across all of the images returned by the image search engine. Those features relevant to the object of the query tend should have much higher frequency of occurrence. As such, the features relevant to the object of the query may form bigger, more compact clusters than those features that are not relevant to the object of the query, which by contrast may be sparsely distributed in the feature space. The feature clustering process therefore acts as an outlier rejection scheme that retains consistent object features while removing background noise features. In short, the feature clustering process determines which of the image features extracted from the images returned by the image search engine occur most frequently.

Based on the results of the clustering, a set of image features most representative of the object of the query is determined. The image features that occur most frequently in the images returned by the image search engine are organized (block 330) into the set of most representative features. The set of most representative features may then be used by, for example, an object recognition module (115, FIG. 1) to identify the object in unknown images.

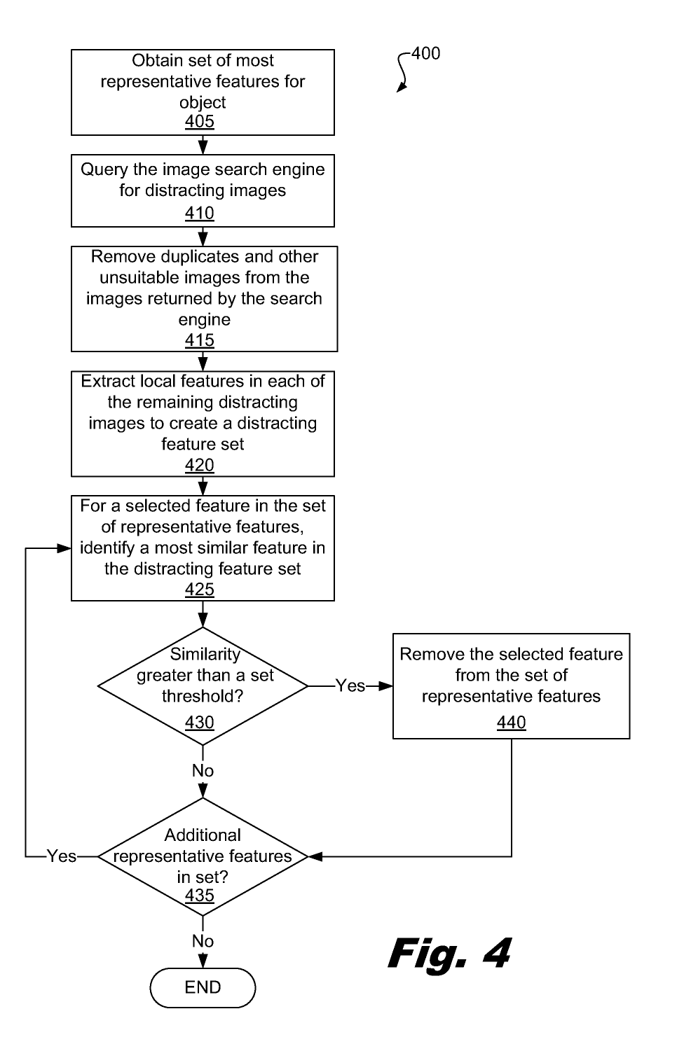

FIG. 4 is a flowchart diagram of an illustrative method (400) of further refining a set of most representative features obtained by the methods (200, 300) of FIGS. 2-3. The features selected using feature clustering in FIGS. 2-3 may contain features that also appear in other object categories. For example, if the object of the query in FIG. 2 or FIG. 3 is a Christmas tree, the set of most representative features may determined for a Christmas tree by the method of FIG. 2 or FIG. 3 may include features that are not exclusive to Christmas trees (e.g., features that are common to evergreen trees in general). By eliminating these confusing features from the set of most representative features, a more accurate set of representative features for an object may be produced. This greater accuracy in the set of most representative features may in turn increase the accuracy of an object detector relying on the set of most representative features to detect the object in other images.

For at least these reasons, the method (400) of FIG. 4 uses discriminative feature selection to remove confusing features from the set of most representative features for an object. The method (400) begins by obtaining (block 405) the set of most representative features for an object produced by the method (200, 300) of FIG. 2 or FIG. 3. The image search engine is then queried (block 410) for distracting images, images that are similar to, but distinct from the original object. For example, if the set of most representative features is for a Christmas tree object, the image search engine may be queried for “trees” or “evergreen trees.”

Unsuitable images (e.g., duplicates and images that are too small) may be removed (block 415) from the set of distracting images returned by the search engine. The local features of each of the remaining distracting images may then be extracted (block 420) to create a distracting feature set. The features may be extracted from the distracting images and a feature descriptor may be generated for each feature using the same methodology used to extract and describe the features of the images as in FIG. 3. For example, each feature may be located using a Hessian affine feature detector to localize each feature and an OSID feature descriptor to describe the appearance of the patch around the feature center.

Once the distracting feature set has been created, for each feature in the set of most representative features for the object, a nearest neighbor is found in the distracting feature set. If the difference between the feature from the set of most representative features and its nearest neighbor in the distracting feature set is smaller than a predefined threshold, than that feature is removed from the set of most representative features for the object.

One manner of accomplishing this functionality is shown in blocks 425 to 440 of the method (400) of FIG. 4. At block 425, for a selected feature in the set of representative features, a most similar feature in the distracting feature set is found. In order to make this search process faster, a k-dimensional (KD) tree may be built for the distracting feature set. A determination is then made (block 430) if the similarity between the selected feature and the most similar feature in the distracting feature set is greater than a set threshold. If so, the selected feature is removed (block 440) from the set of representative features. This process is performed for each feature in the initial set of most representative features (block 435).

At the end of the method (400) of FIG. 4, a refined set of representative features for an object may be produced. This set of representative features may be used to train an object detector or object recognition module (115, FIG. 1) to detect the object from an image.

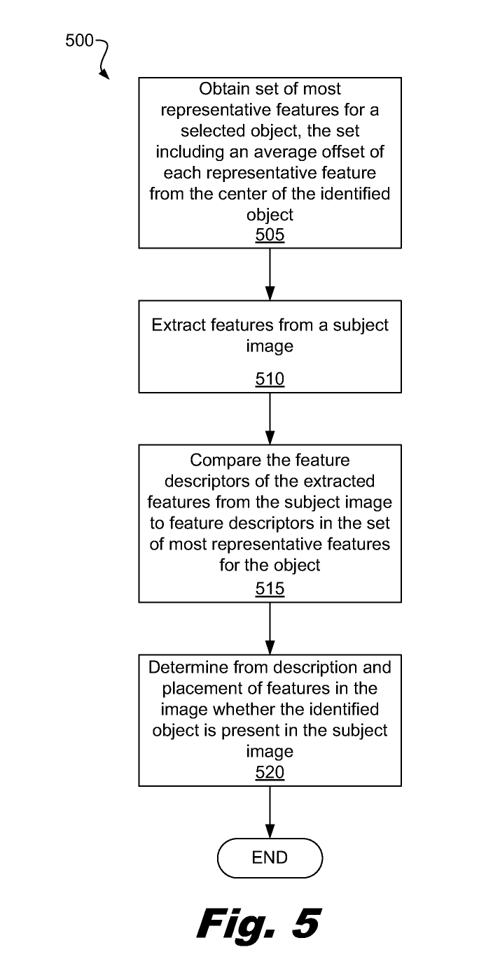

FIG. 5 is a flowchart diagram of an illustrative method (500) of detecting an object in a subject image. In the method (500), a set of most representative features for a selected object is obtained (block 505). The set may be organized as a codebook of the representative feature OSID descriptors and their geometric relationship with respect to the object center. The codebook may be constructed by analyzing the features extracted from the training images returned by the image search engine in the method (200) of FIG. 2. In certain examples, each entry of the codebook may denoted as eᵢ={fᵢ, dxᵢ, dyᵢ}, I=1, . . . , N where fᵢ is the OSID feature descriptor and dxᵢ, dyᵢ is the offset of the feature point to the center of the object. The codebook containing the set of most representative features for the selected object may be associated with the selected object in a database of the object detector.

The features of the subject image are then extracted (block 510) and a feature descriptor is determined for each extracted feature. The feature descriptors of the features extracted from the subject image are compared (block 515) to the feature descriptors of the set of most representative features for the object. The presence of any of the representative features described in the codebook in the subject image may cast a vote for the presence of the object in the subject image. Each of the representative features found in the subject image may be aggregated together to form a prediction for the object location, based on the information in the codebook.

For an image Iₖ, km features are detected and denoted as Iₖ={(f_{k,l}, l_{k,l}), . . . , (f_{k,km}, l_{k,km})}, where f_{k,j} is the feature vector and l_{k,j} is the location of the feature. The object is denoted as O and the possible location of the object is L such that the probability of the object occurring at the position is:

$$P ( O , L ) {\sum }_{i = 1 , … , N}^{ } {\sum }_{j = 1 , … , km}^{ } P ( O , L \vert {e}_{i} ) P ( {e}_{i} \vert {f}_{k , j} , {l}_{k , j} )$$

where P(O,L|eᵢ) is the vote for the codebook entry eᵢ at the position L for the object's presence. During training, all the relative positions of each individual feature to the object center are stored as a lookup table. P(eᵢ|f_{k,j},l_{k,j}) measures how a feature extracted from the subject image matches, or substantially conforms to, a codebook entry. The more similar the feature of the subject image is to the entry, the higher confidence the codebook entry can cast the vote to the final confidence map. The similarity between feature of the analyzed image and a codebook entry is defined as a function of the Euclidean distance between the OSID feature descriptor of the feature of the subject image and the codebook entry:

$$P ( {e}_{i} \vert {f}_{k , j} , {l}_{k , j} ) = \frac{1}{T} exp ( - \frac{‖ {f}_{k , j} - {f}_{i} ‖}{{σ}^{2}} )$$

A determination can therefore be made (block 520) from the descriptors and placements of extracted features in the subject image whether the object is present in the subject image. The final location of the object, if detected in the subject image, is the peak of the confidence map:

$${L}^{*} = {arg max}_{L} P ( O , L )$$

To detect the object at different sizes, multi-scale object detection may be used by iteratively down-sampling the original image by a small fraction (e.g., 0.8) and applying the above detection procedure on each iteration and aggregating the detection results.

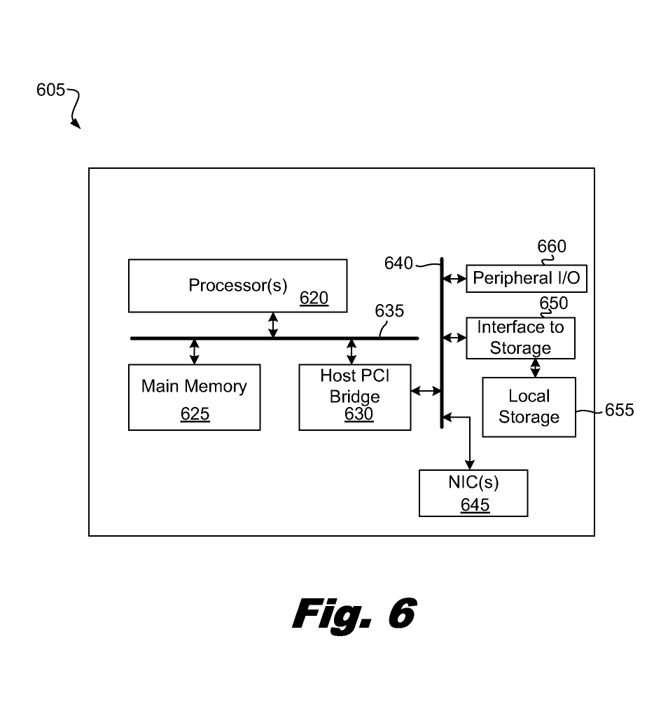

FIG. 6 is a block diagram of an illustrative computing device (605) that may be used to implement any of the image search engine host (105), the object learning module (110), and the object recognition module (115) of FIG. 1 consistent with the principles described herein. Additionally or alternatively, the illustrative computing device (605) may implement any of the methods (200, 300, 400, 500) of FIGS. 2-5 of the present specification.

In this illustrative device (605), an underlying hardware platform executes machine-readable instructions to exhibit a desired functionality. For example, if the illustrative device (605) implements an object learning module (110, FIG. 1), the machine-readable instructions may include at least instructions for querying an image search engine for an object, removing unsuitable images from the images returned by the search engine, extracting local features from the remaining images returned by the search engine, creating feature descriptors of the optical characteristics of each extracted feature, and clustering identified features to determine a set of most representative features of the object.

In another example, if the illustrative device (605) implements an object recognition module (115, FIG. 1), the illustrative device (605) may include machine-readable instructions for obtaining a set of the most representative features for a selected object, extracting features from a subject image, comparing the feature descriptors of the extracted features from the subject image to feature descriptors in the set of most representative features for the object, and determine from the description and placement of features in the image whether the identified object is present in the subject image.

The hardware platform of the illustrative device (605) may include at least one processor (620) that executes code stored in the main memory (625). In certain examples, the processor (620) may include at least one multi-core processor having multiple independent central processing units (CPUs), with each CPU having its own L1 cache and all CPUs sharing a common bus interface and L2 cache. Additionally or alternatively, the processor (620) may include at least one single-core processor.

The at least one processor (620) may be communicatively coupled to the main memory (625) of the hardware platform and a host peripheral component interface bridge (PCI) (630) through a main bus (635). The main memory (625) may include dynamic non-volatile memory, such as random access memory (RAM). The main memory (625) may store executable code and data that are obtainable by the processor (620) through the main bus (635).

The host PCI bridge (630) may act as an interface between the main bus (635) and a peripheral bus (640) used to communicate with peripheral devices. Among these peripheral devices may be one or more network interface controllers (645) that communicate with one or more networks, an interface (650) for communicating with local storage devices (655), and other peripheral input/output device interfaces (660).

The configuration of the hardware platform of the device (605) in the present example is merely illustrative of one type of hardware platform that may be used in connection with the principles described in the present specification. Various modifications, additions, and deletions to the hardware platform may be made while still implementing the principles described in the present specification.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method of optically characterizing an object, said method comprising:
in an object learning system implemented by at least one processor, querying an image search engine for the object;
extracting image features from a plurality of images returned by the search engine with the object learning system in response to the query;
clustering the image features extracted from the plurality of images with the object learning system according to similarities in optical characteristics of the image features; and
determining a set of image features most representative of the object based on the clustering with the object learning system.

2. The method of claim 1, in which determining the set of image features most representative of the object comprises:
determining which of the image features extracted from the plurality of images occur most frequently in the plurality of images; and
adding the image features that occur most frequently in the plurality of images to the set of image features most representative of the object.

3. The method of claim 1, further comprising:
receiving from the search engine a second plurality of images showing subject matter that are similar to and distinct from the object;
extracting image features from the second plurality of images;
for each image feature in the set of image features most representative of the object, removing that image feature from the set of image features most representative of the object if a similarity between that image feature and an image feature extracted from the second plurality of images is determined to be greater than a predetermined threshold.

4. The method of claim 1, in which the optical characteristics of the image features are derived from a combination of ordinal and spatial labeling.

5. The method of claim 1, further comprising removing duplicate images from the set of images returned by the search engine prior to extracting the image features from the plurality of images returned by the search engine.

6. The method of claim 1, further comprising associating the set of image features most representative of the object with the object in a database of an optical object detector.

7. A method of optically recognizing an object, said method comprising:
in an electronic system implemented by at least one processor, determining a set of image features most representative of an object by querying an image search engine for the object and identifying a set of most common image features extracted from a plurality of images returned by the image search engine according to similarities in optical characteristics of the image features;
receiving a subject image separate from said plurality of images returned by the image search engine;
extracting image features from the subject image; and
determining whether the object appears in the subject image by comparing the image features extracted from the subject image with the set of image features most representative of the object.

8. The method of claim 1, in which determining the set of image features most representative of the object comprises:
determining which of the image features extracted from the plurality of images occur most frequently in the plurality of images; and
adding the image features that occur most frequently in the plurality of images to the set of image features most representative of the object.

9. The method of claim 1, further comprising:
receiving from the search engine a second plurality of images showing subject matter that are similar to and distinct from the object;
extracting image features from the second plurality of images;
for each image feature in the set of image features most representative of the object, removing that image feature from the set of image features most representative of the object if a similarity between that image feature and an image feature extracted from the second plurality of images is determined to be greater than a predetermined threshold.

10. The method of claim 1, in which the optical characteristics of the image features are derived from a combination of ordinal and spatial labeling.

11. The method of claim 1, further comprising removing duplicate images from the set of images returned by the search engine prior to extracting the image features from the plurality of images returned by the search engine.

12. The method of claim 1, further comprising associating the set of image features most representative of the object with the object in a database of an optical object detector.

13. A system, comprising:
at least one processor;
a memory communicatively coupled to the at least one processor, the memory comprising executable code that, when executed by the at least one processor, causes the at least one processor to:
query an image search engine for the object;
extract image features from a plurality of images returned by the search engine in response to the query;
cluster the image features extracted from the plurality of images according to similarities in optical characteristics of the image features; and
determine a set of image features most representative of the object based on the clustering.

14. The system of claim 13, said executable code causing said processor to:
determine which of the image features extracted from the plurality of images occur most frequently in the plurality of images; and
add the image features that occur most frequently in the plurality of images to the set of image features most representative of the object.

15. The system of claim 13, said executable code causing said processor to:
receive from the search engine a second plurality of images showing subject matter that are similar to and distinct from the object;
extract image features from the second plurality of images;
for each image feature in the set of image features most representative of the object, remove that image feature from the set of image features most representative of the object if a similarity between that image feature and an image feature extracted from the second plurality of images is determined to be greater than a predetermined threshold.
